(19) United States
(12) Patent Application Publication
(10) Pub. No.: US 2018/0106458 A1
(43) Pub. Date: Apr. 19, 2018

(54) LAMP HAVING AN IMPROVED LIGHTING PORTION

(71) Applicant: SOWDENLIGHT LTD, Peterborough (GB)

(72) Inventor: George J. SOWDEN, Milano (IT)

(21) Appl. No.: 15/568,338

(22) PCT Filed: Apr. 21, 2016
(86) PCT No.: PCT/IB2016/052270

§ 371 Date: Oct. 20, 2017

(30) Foreign Application Priority Data
Apr. 22, 2015 (IT) 102015000012674

(51) Int. Cl. F21V 3/02; F21K 9/235; F21K 9/238; F21K 9/232; F21K 9/237; F21V 29/77

(52) U.S. Cl. CPC F21V 3/02; F21K 9/235; F21K 9/238; F21Y 2115/10; F21K 9/237; F21V 29/77; F21K 9/232

(57) ABSTRACT

A lamp includes a fitting portion configured for being connected to an external source of electric power. A control module mounts on the fitting portion and is configured for receiving electric power from the fitting portion. A lighting portion mounts, in an optionally removable and spaced manner, on the control module and electrically connects to the control module in such a way as to be able to provide a luminous emission. The lighting portion includes a hollow body made of transparent or semi-transparent material and an intermediate element carried by the hollow body and having a plurality of light sources, in particular a plurality of LEDs. The hollow body includes an axial pass-through cavity facing towards the intermediate element. Through the lamp a luminous emission distribution is achieved that can be configured in accordance with lighting or design requirements.

### DESCRIPTION

### Technical field

The present invention relates to a lamp.

### Background art

Lamps are commonly known in the art which are equipped with LEDs or low-consumption and which consist of a replaceable device conceived for emitting light starting from electric power.

Lamps typically comprise a fitting portion configured for being connected to an external source of electric power; a control module mounted on the fitting portion and configured for receiving electric power from the latter; and a lighting portion mounted on the control module and electrically connected to the latter in such a way as to be able to provide a luminous emission. The lighting portion comprises a hollow body made of transparent or semi-transparent material.

### SUMMARY OF THE INVENTION

It is one object of the present invention to provide a lamp which can overcome the drawbacks of the prior art, while at the same time being simple and economical to manufacture.

According to the present invention, this and other objects are achieved through a lamp having the technical features set out in the appended independent claim.

It is to be understood that the appended claims are an integral part of the technical teachings provided in the following detailed description of the invention. In particular, the appended dependent claims define some preferred embodiments of the present invention, which include some optional technical features.

With reference to the embodiments described and illustrated herein by way of non-limiting example, the present invention offers several optional and preferred advantages.

For example, according to further advantageous aspects of the present invention, the lamp can be so designed as to be lighter in weight while being highly efficient in terms of energy consumption and luminous emission. Moreover, according to further advantageous aspects, this lamp allows—depending on the installation configuration of the light sources—defining the field of illumination by directing and orienting it as required. According to other advantageous aspects, the lamp can be made disassembleable and can be manufactured by using recycled or recyclable material (e.g. bioplastic), in addition to the fact that such a lamp may also have a pleasant, ergonomical and customizable design.

Further features and advantages of the present invention will become apparent from the following detailed description, which is supplied by way of non-limiting example with particular reference to the annexed drawings, which will be summarized below.

### BRIEF DESCRIPTION OF THE DRAWINGS

FIG. 1 is a perspective view of a lamp in accordance with an illustrative embodiment of the present invention.

FIG. 2 is an exploded perspective view of the lamp shown in FIG. 1.

FIG. 3 is a partially sectional view of the lamp shown in the preceding figures.

FIG. 4 is a top view of the lamp shown in the preceding figures.

FIGS. 5 to 9 are pairs of views, wherein each pair of views includes a perspective longitudinal sectional view and a schematic view, which illustrate different lamps and fields of illumination obtainable therefrom, in accordance with three different embodiments of the present invention.

FIGS. 11 and 12 are three perspective views of another lamp realized in accordance with a preferred embodiment of the present invention.

### DETAILED DESCRIPTION OF THE INVENTION

With particular reference to the drawings, reference numeral 10 designates as a whole a lamp structured in accordance with one exemplary embodiment of the present invention.

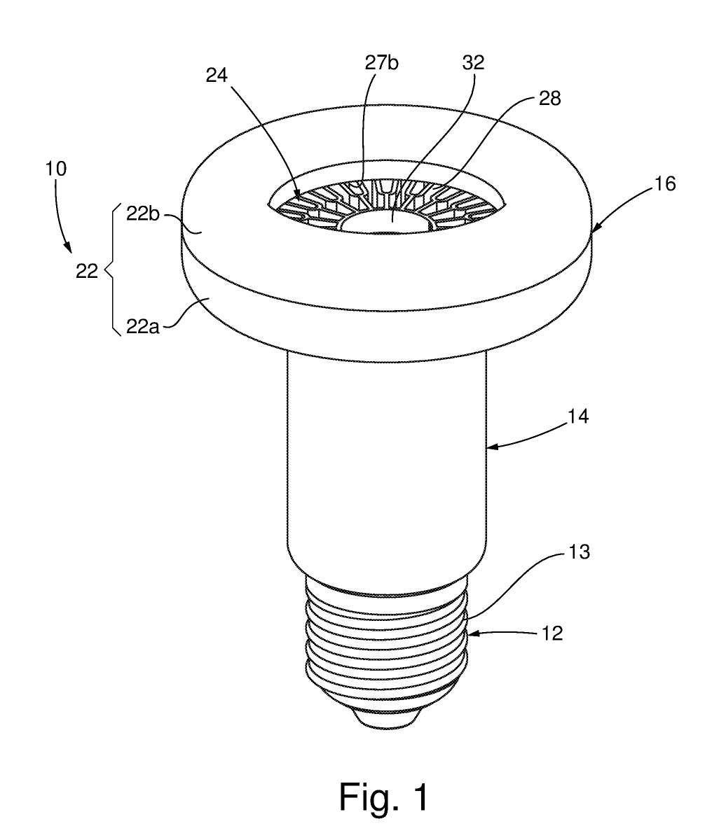

With particular reference to FIG. 1, lamp 10 comprises a fitting portion 12 configured for being connected to a lamp-holding structure electrically supplied by an external source of electric power, e.g. the electric mains, typically through an electric outlet. Lamp 10 further comprises a control module 14 mounted on fitting portion 12 and configured for receiving electric power through the latter. Furthermore, the lamp comprises a lighting portion (or bulb) 16 mounted on control module 14 and electrically connected to the latter in such a way as to be able to provide a luminous emission.

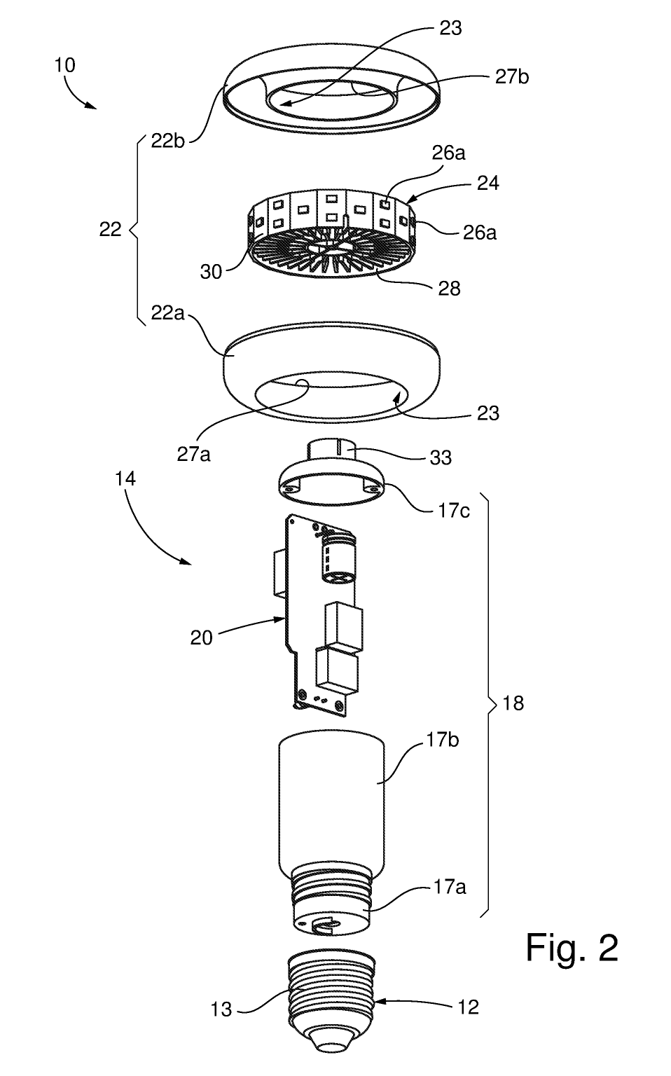

In the embodiment illustrated more in detail in FIG. 2, fitting portion 12 has a peripheral screw-type outer thread 13 to be inserted into a corresponding complementary inner thread in the lamp holder in order to establish the electric connection with the external source of electric power. In particular, fitting portion 12 acts as a male connection element adapted to be electrically connected to the lamp holder, which acts as a female connection element.

In the illustrated embodiment, control module 14 comprises a casing 18 that houses a control circuit, in particular a printed circuit board 20.

In particular, casing 18 is mechanically connected to fitting portion 12, thus supporting it and connecting it to lighting portion 16. Printed circuit board 20 is configured for being electrically connected, in a manner per se known to those skilled in the art, to fitting portion 12 so as to be able to receive the electric power supplied by the external source of electric power.

Preferably, casing 18 includes a cup-shaped portion 17a, on which fitting portion 12 can be superimposed, and from which a widened portion 17b extends transversally, which is also internally hollow.

In particular, casing 18 is also provided with a closing portion 17c, secured to the top of widened portion 17b (e.g. screwed thereto).

In particular, printed circuit board 20 is housed within a cavity defined by housing 18. In the illustrated embodiment, said cavity is defined by and enclosed within portions 17a, 17b and 17c of casing 18.

By way of example, casing 18 (in particular, its portions 17a, 17b and 17c) is made of plastic material, e.g. by injection moulding. Preferably, casing 18 is made of biodegradable plastic, e.g. derived from maize cellulose.

In the illustrated embodiment, printed circuit board 20 can convert (in a manner per se known to those skilled in the art) the electric power received at its input, typically alternating current from the electric mains, in such a way as to output direct-current power. In particular, printed circuit board 20 has a shape which is substantially complementary to the axial or longitudinal section of casing 18.

In the illustrated embodiment, lighting portion 16 comprises a hollow body 22 made of transparent or semi-transparent material (or anyway a material that can be crossed by a luminous emission within the visible light range), secured to control module 14.

In the illustrated embodiment, as will be explained more in detail below, hollow body 22 is reversibly disassembleable. In particular, hollow body 22 comprises a first half-shell 22a and a second half-shell 22b which can be reversibly coupled together in an axial mounting direction. Alternatively, hollow body 22 may also be structured otherwise, e.g. as one monolithic piece. More specifically, the first half-shell 22a and the second half-shell 22b are adapted to mate at their periphery by means of a snap coupling, as they are abutted on each other and pushed closer in the axial direction. Advantageously but not necessarily, the coupling is effected via superimposition of juxtaposed lateral surfaces, which are brought close to each other, one over the other, and pushed until mutual mechanical interference occurs, which will create a constraint that will ensure a stable connection between them.

In the illustrated embodiment, hollow body 22 has an axial pass-through cavity 23, in particular situated centrally. Preferably, the axial pass-through cavity 23 is defined by respective central edges of the first half-shell 22a and of the second half-shell 22b.

In particular, the hollow body 22 has a substantially toroidal or “ring-like” shape.

In particular, lighting portion 16 further comprises an intermediate element 24 carried by hollow body 22. Advantageously but not necessarily, intermediate element 24 is substantially discoidal in shape.

As will be described more in detail below, intermediate element 24 has a plurality of light sources, in particular a plurality of LEDs.

Advantageously but not necessarily, the plurality of light sources is arranged on the periphery of intermediate element 24.

In the illustrated embodiment, axial pass-through cavity 23 in hollow body 22 faces towards the intermediate element 24, in particular towards a substantially central portion thereof.

In particular, axial pass-through cavity 23 is crossed transversally by intermediate element 24.

Preferably, the plurality of light sources comprises a plurality of lateral light sources 26a directed transversally, in particular radially, towards the outside of hollow body 22 and electrically connected to printed circuit board 20. In the illustrated embodiment, lateral light sources 26a are secured to an annular surface transversally, in particular radially, external to intermediate element 24.

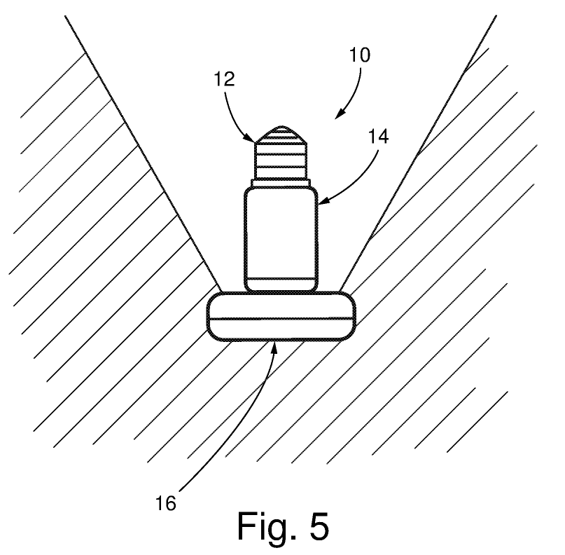

In the illustrated embodiment, the layout of the light sources has been so conceived that the sum of the light beams emitted by the light sources, combined together, will create an emission such that a distribution as close as possible to 360°, i.e. a luminous emission as “spherical” as possible, will be attained (apart from a rear dark region, as shown and described more in detail with reference in FIG. 5).

In the illustrated embodiment, lateral light sources 26a are substantially of the punctiform type and are evenly distributed transversally, in particular radially, over the outer annular surface of intermediate element 24. The light beams generated by each lateral light source 26a are directed transversally or radially towards the outside of intermediate element 24, and hence of hollow body 22. In particular, the light beams emitted by lateral light sources 26a diverge radially away from a longitudinal axis of intermediate element 24, and hence of hollow body 22. Preferably, lateral light sources 26a comprise a plurality of LEDs. In particular, the surface of each LED faces towards the outside of intermediate element 24, and hence of hollow body 22. In this regard, it must be pointed out that—as will become apparent hereafter—the LEDs can be positioned or inclined in such a way as to orient and diffuse the light as desired.

For example, the electric connection between light sources 26 and printed circuit board 20 can be established, in a per se known manner, by means of electric cables or electrically conductive tracks (not shown) coming from casing 18 and entering hollow body 22.

Preferably, the plurality of light sources comprises a plurality of axial light sources 26b converging axially towards the outside of hollow body 22 and electrically connected to printed circuit board 20. In the illustrated embodiment, axial light sources 26b are secured to at least one annular surface of intermediate element 24.

Axial light sources 26b are of a substantially punctiform type and are evenly distributed over said annular surface of intermediate element 24, which—in the illustrated embodiment—acts as a heat sink.

In particular, axial light sources 26b are arranged on the periphery of intermediate element 24.

In the illustrated embodiment, the annular surface on which axial light sources 26b are secured is inclined in a manner such as to slightly protrude inwards from the periphery. Thus, the light beams emitted by axial light sources 26b will converge axially towards the longitudinal axis of lamp 10.

As described in regard to lateral light sources 26a, axial light sources 26b comprise a plurality of LEDs. Therefore, for the sake of brevity reference should be made to the above description for such features.

In the illustrated embodiment, intermediate element 24 protrudes transversally, in particular radially, towards the inside of hollow body 22. In particular, intermediate element 24 is at least partly exposed to the air through axial pass-through cavity 23 defined by hollow body 22.

In the illustrated embodiment, intermediate element 24 is arranged and held in a substantially “sandwich” fashion between the two half-shells 22a and 22b, in particular at internal edges 27a and 27b of the latter.

In particular, intermediate element 24 comprises a heat sinking structure 28 situated in a substantially central position. In the illustrated embodiment, heat sinking structure 28 faces—with at least a part thereof—towards axial pass-through cavity 23.

Preferably, intermediate element 24 has a substrate 30, e.g. made from a film of plastic material (in particular, an amide). In the illustrated embodiment, the film of plastic material is made of Kapton, the chemical name of which is poly(4,4′-oxydiphenylene-pyromellitimide).

Substrate 30 is situated in a radially external position, where lateral light sources 26a and/or axial light sources 26b are secured.

As will be apparent to those skilled in the art, the configuration of heat sinking structure 28 is advantageously able to dissipate heat regardless of the position and orientation of lamp 10 when mounted to the lamp holder. In particular, whether lighting portion 16 is oriented upwards or downwards, the heat sinking performance will remain substantially unchanged.

In the illustrated embodiment, substrate 30 is, for example, glued (or otherwise secured) to the inside of heat sinking structure 28.

Preferably, heat sinking structure 28 has a substantially branched shape that extends transversally or radially outwards in a sunburst pattern. In the illustrated embodiment, heat sinking structure 28 includes a plurality of fins arranged in a sunburst pattern, which protrude transversally, in particular, radially, outwards. Each fin comprises a proximal extension 28a and a distal bifurcation or ramification 28b starting from proximal extension 28a. In the illustrated embodiment, proximal extensions 28a converge radially inwards towards a central ring 32.

In the illustrated embodiment, heat sinking structure 28 is made of a material having high thermal conductivity, e.g. metal, such as aluminium. As an alternative, heat sinking structure 28 may be made of ceramic, or plastic based on thermally conductive polymers.

In the illustrated embodiment, half-shells 22a and 22b are removably connected to intermediate element 24. This makes lamp 10, in particular its lighting portion 16, easier to disassemble, thus facilitating the repair, replacement, recycling , and splitting up of the components contained therein.

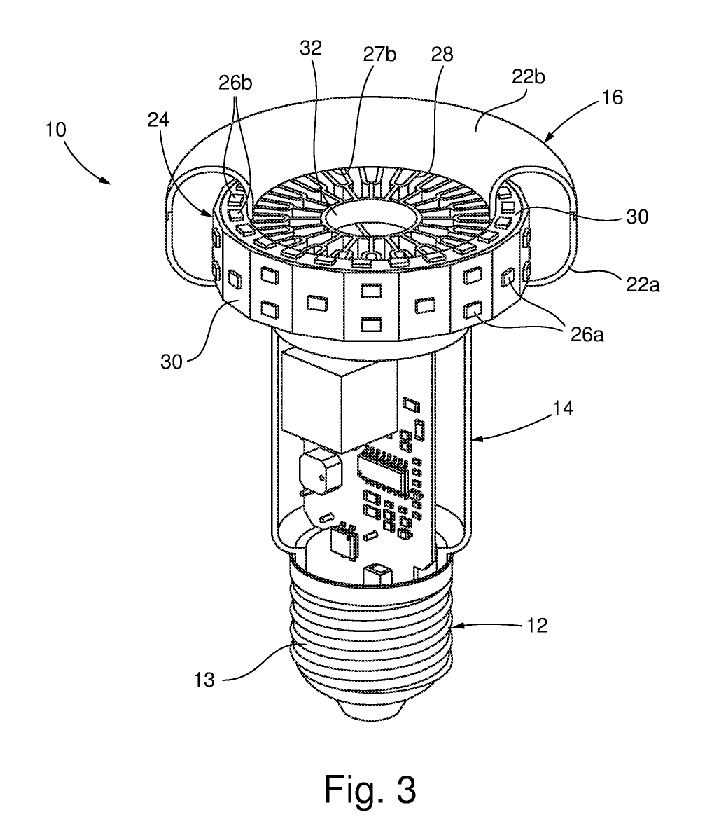

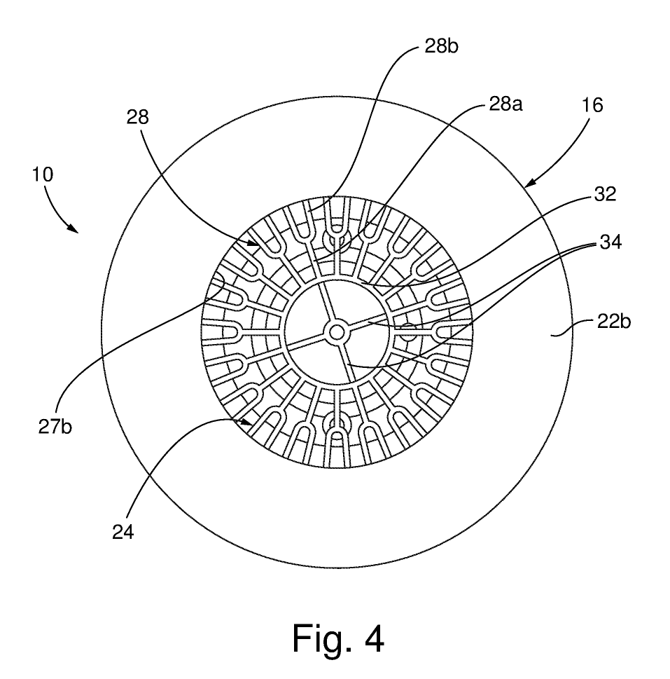

As clearly visible in FIGS. 2 and 3, in particular, during the assembly process abutted edges 27a, 27b of half-shells 22a, 22b are transversally superimposed on intermediate element 24. For example, abutted edges 27a, 27b are superimposed on heat sinking structure 28, in particular abutting axially against distal bifurcations or ramifications 28b. In the illustrated embodiment, the annular cavity defined by half-shells 22a, 22b encloses lateral light sources 26a and axial light sources 26b (which are, for example, supported by respective substrates 30).

By way of example, half-shells 22a, 22b are made of plastic material, e.g. by injection moulding. Preferably, the half-shells are made of biodegradable plastic, e.g. derived from maize cellulose.

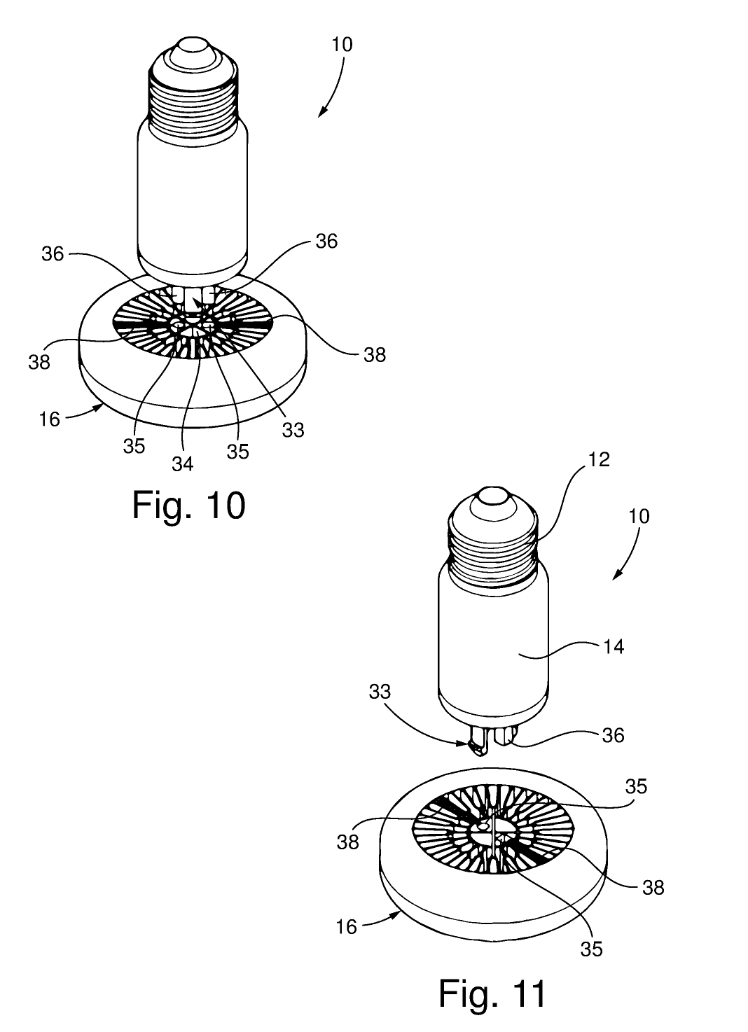

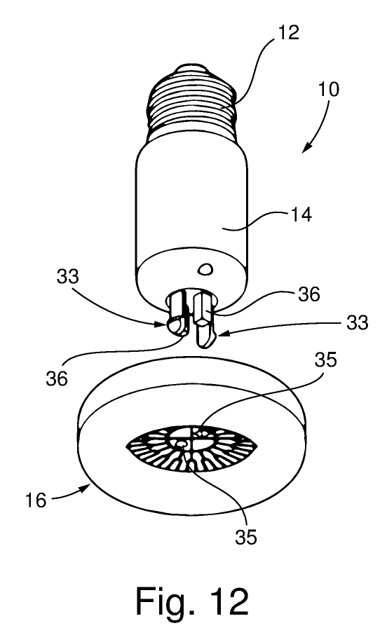

In the embodiment illustrated with particular reference to FIGS. 10 to 12, intermediate element 24, casing 18 and the control circuit (in particular, printed circuit board 20) removably connect lighting portion 16 mechanically and electrically to control module 14.

Preferably, intermediate element 24 and casing 18 are removably connected mechanically to each other via a snap coupling. More preferably, casing 18 comprises a plurality of appendices 33 tending to elastically open out, which can be removably inserted into intermediate element 24. As an alternative, this arrangement may be reversed.

In particular, appendices 33 are carried by casing 18 and can be removably inserted into a central portion of said intermediate element 24, e.g. central ring 32 carried by intermediate element 24.

Preferably, intermediate element 24 and control circuit 20 are removably connected to each other electrically by means of electric connectors of the plug/socket type. More preferably, control circuit 20 and intermediate element 24 comprises a plurality of connecting protrusions 36, the shape of which is complementary to that of connecting seats 35 formed in intermediate element 24.

As an alternative, this arrangement may be reversed.

In particular, connecting protrusions 35 are carried by control circuit 20 and protrude from casing 18. Connecting seats 35 are formed in a central portion of intermediate element 24, e.g. in central ring 32 of intermediate element 24.

Optionally, connecting protrusions 36 may have different shapes from one another. Each connecting protrusion 36 can only be coupled to one respective connecting seat 35. Merely by way of example, FIGS. 10 to 12 show a pair of such shaped protrusions 36, wherein one of them has a substantially square cross-section, whereas the other one has a substantially circular cross-section. Correspondingly, of course, connecting seats 35 are shown as a pair of apertures, wherein each one of them has a cross-section that selectively matches either one of shaped protrusions 36.

In particular, appendices 33 are carried by the top of casing 18 (e.g. by portion 17c).

Preferably, central ring 32 is provided with a plurality of spokes 34, and appendices 33 are adapted to be inserted into the apertures defined between spokes 34 and central ring 32, so as to elastically open out against said apertures, thus effecting said snap coupling.

Advantageously, it is therefore possible to effect a mechanical connection as well, thanks to the coupling between appendices 33 and central ring 32. In this case, no cables will be required for the electric connection, which will be established by means of an electric coupling of the plug/socket type, as previously described.

In the embodiment illustrated in the above-mentioned figures, intermediate element 24 includes electrically conductive tracks 38 for electrically connecting lateral light sources 26a and/or axial light sources 26b to connecting protrusions 36. Preferably, conductive tracks 38 are formed along heat sinking structure 28 (in particular, along the ramifications of the latter). For example, conductive tracks 38 extend radially outwards relative to connecting seats 35.

With reference to FIG. 5, there is schematically shown, by broken lines, a field of illumination obtained by means of lamp 10 shown in the preceding figures. In a condition in which lamp 10 is mounted in its lamp-holding structure, the field of illumination will include the following:
thanks to lateral light sources 26a, an illumination directed laterally and at least partly also directed “backwards”, towards fitting portion 12; and
thanks to the axial light sources 26b, an axial illumination directed “forwards”, away from fitting portion 12, in particular converging towards the longitudinal axis of hollow body 22.

This provides an illumination substantially oriented all around lamp 10, except for the region occupied by the lamp-holding structure, which however will not need to be illuminated.

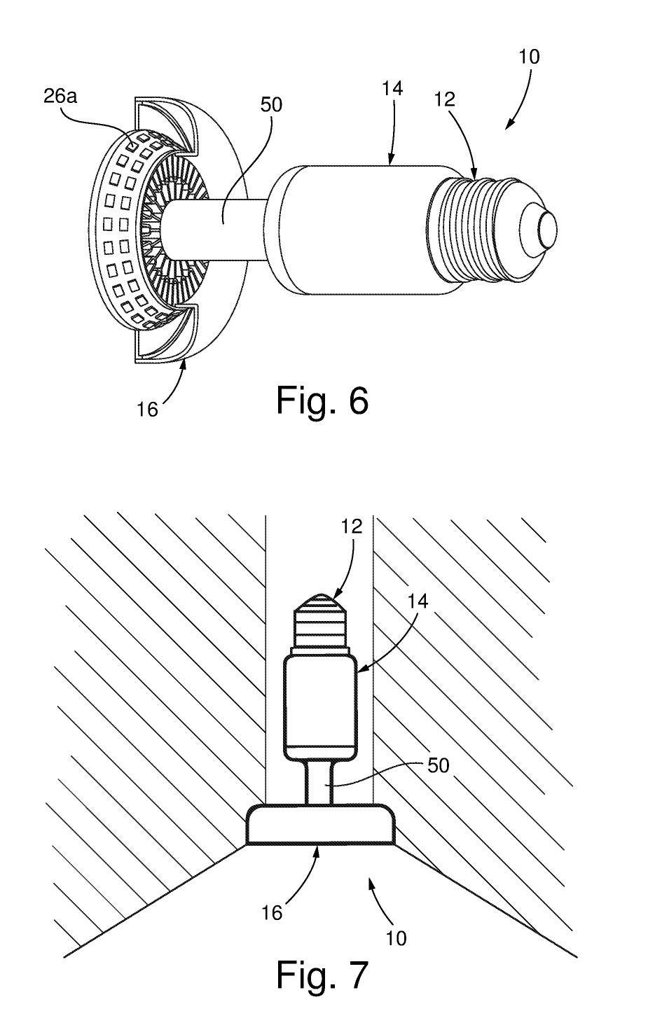

With reference to FIG. 6, there is shown an alternative embodiment of the lamp according to the invention. Unlike the previously illustrated embodiment, lamp 10 includes a spacer 50 for moving fitting portion 12 away from control module 14.

Moreover, in this embodiment the axial light sources are absent (but they may be included in further variants).

With particular reference to FIG. 7, the plurality of lateral light sources 26a can emit a transversally diverging field of illumination. In particular, the field of illumination of the plurality of lateral light sources 26a is directed laterally and “backwards”, i.e. towards fitting portion 12. In this embodiment as well, the field of illumination is shown by broken lines.

In this embodiment, lateral light sources 26a are arranged on an inclined annular surface, and taper in axially in the direction of fitting portion 12.

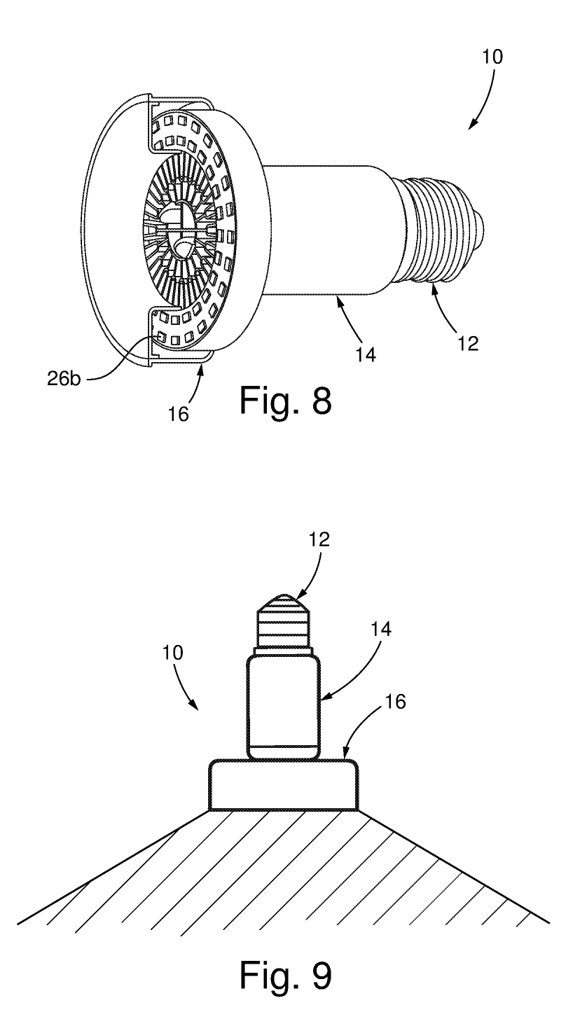

With reference to FIG. 8, there is shown a further alternative embodiment of the lamp according to the present invention.

Unlike the previously illustrated embodiments, the lateral light sources are absent (but they may eventually be included in further variants).

With particular reference to FIG. 9, the plurality of axial light sources 26b is directed axially “forwards”, i.e. away from fitting portion 12. In this embodiment as well, the field of illumination is shown by broken lines.

Of course, without prejudice to the principle of the invention, the forms of embodiment and the implementation details may be extensively varied from those described and illustrated herein by way of non-limiting example, without however departing from the scope of the invention as set out in the appended claims.

For example, unlike the illustrated embodiment, the heat-sinking structure and the substrate of the ring may be made as one piece, of course by using a material having appropriate thermal conductivity properties, so as to promote the cooling required because of the lighting action of the light sources. In particular, the ring may be wholly made of metal, e.g. aluminium.

In particular, according to an implementation variant wherein the ring is made of thermoconductive material, it is possible to solder the LEDs directly to the ring, without needing a printed circuit board or other elements.

The illustrated embodiment includes just one ring in the lighting portion. However, as will be apparent to a man skilled in the art, in alternative embodiments the lighting portion may include a plurality of such rings, respectively spaced from each other in the axial direction. In further implementation variants, it is conceivable to use a plurality of rings axially spaced from each other, with transparent intermediate annular structures in between coupled to the adjacent rings as described for the half-shells of the hollow body. In other words, it is possible to design a modular structure of the lighting portion which extends in the axial direction with multiple rings alternated with multiple intermediate annular structures.

In the illustrated embodiment, the axis of the ring is substantially aligned with the longitudinal axis of the hollow body. However, in further implementation variants the ring may be arranged on an oblique plane relative to the longitudinal axis of the hollow body.

In further implementation variants (not shown), half-shells 22a, 22b may also have shapes other than that proposed in the drawings, forming a hollow body 22 having a geometry and a shape that can virtually be adapted at will.

Other variant embodiments (not shown) may include only one of the plurality of axial light sources 26b and the plurality of lateral light sources 26a. In particular, the electric circuit that controls the luminous emission may be configured for being able to supply power separately to either the plurality of axial light sources 26b or the plurality of lateral light sources 26a. A configuration may also be included wherein said circuit can supply power to both pluralities of axial light sources 26b and lateral light sources 26a.

In a further implementation variant, it is conceivable to create a kit wherein lamp 10 includes a single assembly comprising fitting portion 12 and control module 14, and a plurality of different lighting portions 16 realized as shown in the preceding embodiments, separately and removably mounted to control module 14 and interchangeable between them. Such lighting portions 16 may have different shapes and dimensions. In particular, each one of said lighting portions 16 may have different arrangements of lateral light sources 26a and/or axial light sources 26b, e.g. providing an illumination totally directed in the axial direction, away from fitting portion 12, or an illumination directed both axially and radially, or an axial illumination in two opposite directions, i.e. away from fitting portion 12 and towards fitting portion 12. In this manner, with a single standardized assembly consisting of fitting portion 12 and control module 14, it will be possible to change the illumination shape or effect of lighting portion 16 (and in particular of hollow body 22) simply by selecting and installing that lighting portion 16 which best suits the user's needs; this will considerably reduce the costs incurred for replacing and repairing lamp 10.

1. A lamp comprising:
a fitting portion configured for being connected to an external cource of electric power;
a control module mounted on the fitting portion and configured for receiving electric power from said fitting portion; and
a lighting portion mounted on the control module and electrically connected to said control module to provide a luminous emission;
said lighting portion comprising a hollow body made of transparent or semi-transparent material;
wherein said lighting portion comprises an intermediate element carried by said hollow body and having a plurality of light sources; said hollow body has an axial pass-through cavity at least partly facing towards said intermediate element.

2. A lamp according to claim 1, wherein said axial pass-through cavity is defined centrally.

3. A lamp according to claim 1, wherein said axial pass-through cavity is crossed transversally by said intermediate element.

4. A lamp according to claim 1, wherein said hollow body is substantially toroidal or ring-shaped.

5. A lamp according to claim 1, wherein said hollow body comprises a pair of half-shells that can be coupled together in an axial direction.

6. A lamp according to claim 1, wherein said intermediate element is arranged and held in a substantially sandwich configuration between said half-shells.

7. A lamp according to claim 1, wherein said plurality of light sources is arranged at the periphery of said intermediate element.

8. A lamp according to claim 1, wherein said plurality of light sources comprises at least one of:
a plurality of lateral light sources, each one of the plurality of lateral light sources being configured for emitting a light beam transversally or radially diverging through said hollow body; and
a plurality of axial light sources, each one of the plurality of axial light sources being configured for emitting a light beam axially converging through said hollow body.

9. A lamp according to claim 1, wherein said intermediate element comprises a heat sinking structure located in a substantially central position and at least partly facing towards said axial pass-through cavity.

10. A lamp according claim 1, wherein said lighting portion and said control module are mechanically and/or electrically connected in a removable manner through said intermediate element.

11. A lamp according to claim 1, wherein said plurality of light sources comprises a plurality of light emitting diodes (LEDs).

12. A lamp according to claim 1, wherein said intermediate element is arranged and held in a substantially sandwich configuration between internal edges of said half-shells.

13. A lamp according claim 1, wherein said lighting portion and said control module are mechanically and/or electrically connected in a removable manner through said intermediate element.
